(19) United States
(12) Patent Application Publication
(10) Pub. No.: US 2026/0225663 A1
(43) Pub. Date: Aug. 6, 2026

(54) VEHICLE BODY STRUCTURE AND METHOD OF MANUFACTURING VEHICLE BODY

(71) Applicant: TOYOTA JIDOSHA KABUSHIKI KAISHA, Toyota-shi (JP)

(72) Inventors: Mutsumi KAWASHIMA, Nisshin-shi (JP); Naoki IKUHARA, Kariya-shi (JP)

(73) Assignee: TOYOTA JIDOSHA KABUSHIKI KAISHA, Toyota-shi (JP)

(21) Appl. No.: 19/380,992

(22) Filed: Nov. 6, 2025

(30) Foreign Application Priority Data
Jan. 31, 2025 (JP) 2025-015540

(51) Int. Cl. B62D 25/08; B62D 21/02; B62D 27/06; B62D 29/00; B62D 65/02

(52) U.S. Cl. CPC B62D 25/085; B62D 21/02; B62D 27/065; B62D 29/00; B62D 65/024

(57) ABSTRACT

A vehicle body includes a front part that is a metal casting and includes a main body portion and a connecting portion provided on a vehicle front side of the main body portion and open to a vehicle lower side, and a side member that extends in a vehicle front-rear direction and is connected to the connecting portion in a state where an end portion on a vehicle rear side is disposed into the connecting portion.

### CROSS-REFERENCE TO RELATED APPLICATION

This application claims priority to Japanese Patent Application No. 2025-015540 filed on January 31, 2025. The disclosure of the above-identified application, including the specification, drawings, and claims, is incorporated by reference herein in its entirety.

### BACKGROUND

### 1. Technical Field

The present disclosure relates to a vehicle body structure and a method of manufacturing a vehicle body.

### 2. Description of Related Art

Japanese Unexamined Patent Application Publication No. 2007-191061 (JP 2007-191061 A) discloses an disclosure relating to a vehicle body front structure. In the vehicle body front structure, a vehicle body front portion is divided into a front engine compartment and a rear engine compartment. Then, after an engine or the like is mounted in the front engine compartment, the front engine compartment and the rear engine compartment are joined to each other, thereby completing an assembly work of the vehicle body front portion.

### SUMMARY

However, in the related art, each of the front engine compartment and the rear engine compartment includes a part of a side member. Therefore, upon input of a collision load or the like, at a connection portion between the front engine compartment and the rear engine compartment, a portion where stress becomes concentrated on the side member may occur.

In addition, in the related art, the front engine compartment and the rear engine compartment are configured by combining press-formed members by welding or the like. From the viewpoint of reducing the number of components or the like, the members may be integrally configured with a metal casting.

In view of the above circumstances, a configuration capable of suppressing the occurrence of a portion where stress on the vehicle body increases upon input of a collision load or the like while a part of the vehicle body includes a casting may be adopted.

In this regard, it is considered that, at a connection portion between a cast vehicle body structural component and another vehicle body structural component, the components are connected in a state where a part of one vehicle body structural component is disposed in the other vehicle body structural component along a predetermined insertion direction, to ensure strength at the connection portion.

However, there is a high possibility that a wheel house portion or the like is provided at a vehicle body front portion or a vehicle body rear portion, and in order to construct these portions with a casting, the insertion direction needs to be determined in consideration of a mold releasing direction during casting. That is, the related art has room for improvement in suppressing the complication of a process of manufacturing the vehicle body while the number of components of the vehicle body is reduced, and further in suppressing the occurrence of a portion where stress on the vehicle body becomes high upon input of a collision load or the like.

In consideration of the above-described circumstances, an object of the present disclosure is to obtain a vehicle body structure and a method of manufacturing a vehicle body capable of suppressing the complication of the process of manufacturing the vehicle body while the number of components of the vehicle body is reduced. Furthermore, another object of the present disclosure is to obtain a vehicle body structure and a method of manufacturing a vehicle body capable of suppressing the occurrence of a portion where stress on the vehicle body becomes high upon input of a collision load or the like.

A vehicle body structure according to a first aspect includes:

a vehicle body structural portion configured as a metal casting and including

a main body portion and

a connecting portion provided on a vehicle front side of the main body portion and open to an outer side in a vehicle width direction or a vehicle lower side; and

a side member extending in a vehicle front-rear direction and connected to the connecting portion in a state where an end portion of the side member on a vehicle rear side is disposed in the connecting portion.

According to the vehicle body structure according to the first aspect, the vehicle body structural portion is configured as a metal casting and includes the main body portion and the connecting portion provided on the vehicle front side of the main body portion. Therefore, in the present aspect, the number of components constituting the vehicle body structural portion can be reduced as compared with a configuration in which the main body portion and the connecting portion are made of press-formed members, or the like and the members are combined with each other by welding or the like to constitute the vehicle body structural portion.

In addition, in the present aspect, a side member extending in the vehicle front-rear direction is provided, and an end portion of the side member on a vehicle rear side is connected to the connecting portion of the vehicle body structural portion.

Meanwhile, a portion where stress becomes high may occur at the connecting portion between the side member and the connecting portion upon input of a collision load or the like.

Here, in the present aspect, the end portion of the side member on the vehicle rear side is disposed in the connecting portion, and a bending moment or the like generated upon input of a collision load or the like can be supported by the side member and the connecting portion. In addition, it is possible to suppress the occurrence of a portion where stress becomes high at a connection portion between the side member and the connecting portion upon input of a collision load or the like.

On the other hand, in a case where the vehicle body structural portion is a vehicle body front portion or a vehicle body rear portion, there is a high possibility that a wheel house portion or the like is provided at the vehicle body structural portion. In order to construct these portions with a casting, the insertion direction of the side member into the connecting portion needs to be determined in consideration of the mold releasing direction during casting of the vehicle body structural portion.

Here, in the present aspect, the connecting portion is opened to the outer side in the vehicle width direction or the vehicle lower side, and the insertion direction of the side member into the connecting portion can be aligned with a direction in which the wheel house portion is opened, that is, the mold releasing direction during casting of the vehicle body structural portion.

According to the vehicle body structure according to a second aspect, in the vehicle body structure according to the first aspect, the connecting portion is opened to the vehicle lower side.

In the vehicle body structure according to the second aspect, a connecting portion of the vehicle body structural portion is opened toward the vehicle lower side. A sub-assembly in which a side member and various components are combined can be lifted upward using a lift and attached to the vehicle body structural portion.

According to the vehicle body structure according to a third aspect, in the vehicle body structure according to the second aspect, a protruding portion extending in a vehicle up-down direction is provided on an inner peripheral side of the connecting portion, and a groove portion into which the protruding portion is fitted is provided in the side member.

In the vehicle body structure according to the third aspect, the protruding portion extending in the vehicle up-down direction is provided on the inner peripheral side of the connecting portion of the vehicle body structural portion, and a groove portion into which the protruding portion is fitted is provided in the side member. Therefore, in the present aspect, the positioning of the connecting portion and the side member can be performed using the protruding portion and the groove portion as guides. In addition, a bending moment acting on the side member can be supported by the protruding portion.

A method of manufacturing a vehicle body according to a fourth aspect includes:

inserting, from a vehicle lower side, an end portion of a side member on a vehicle rear side into a connecting portion that extends from a main body portion of a vehicle body structural portion made of a metal casting, and that is open to the vehicle lower side; and connecting the connecting portion and the side member.

According to the method of manufacturing a vehicle body according to the fourth aspect, the vehicle body structural portion is configured as the metal casting including the main body portion and the connecting portion extending from the main body portion and is open to the vehicle lower side. The end portion of the side member on the vehicle rear side is disposed in the connecting portion from the vehicle lower side to connect the connecting portion and the side member.

Therefore, in the present aspect, as in the first aspect, the number of components constituting the vehicle body structural portion can be reduced. Further, it is possible to suppress the occurrence of a portion where stress becomes high at a connection portion between the side member and the connecting portion upon input of a collision load or the like. In addition, as in the second aspect, a sub-assembly including the side member can be lifted upward using a lift and attached to the vehicle body structural portion.

As described above, the vehicle body structure and a method of manufacturing a vehicle body according to the present disclosure have an excellent effect capable of suppressing complication in the process of manufacturing the vehicle body while the number of components of the vehicle body is reduced. The vehicle body structure and the method further have an excellent effect capable of suppressing occurrence of a portion where stress becomes concentrated upon input of a collision load or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a configuration of a vehicle body to which a vehicle body structure according to the present embodiment is applied;

FIG. 2 is a cross-sectional view schematically showing a configuration of a main portion of the vehicle body to which the vehicle body structure according to the present embodiment is applied (cross-sectional view showing a state where the vehicle body is cut along line 2-2 of FIG. 1); and

FIG. 3 is a cross-sectional view schematically showing a configuration of a main portion of the vehicle body to which the vehicle body structure according to Modification of the present embodiment is applied (cross-sectional view corresponding to FIG. 2).

### DETAILED DESCRIPTION OF EMBODIMENTS

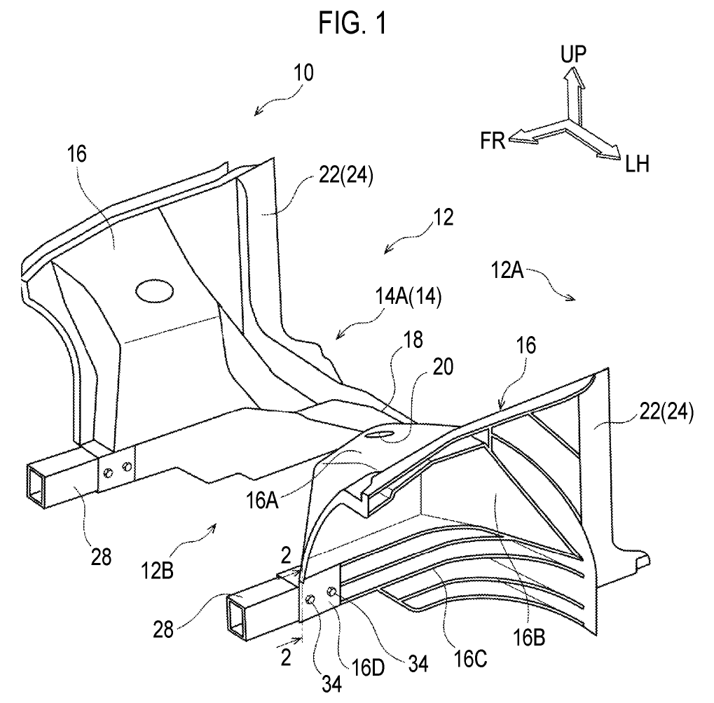

Hereinafter, an example of the vehicle body structure according to the present disclosure will be described with reference to FIGS. 1 to 3. An arrow FR shown in each drawing as appropriate indicates a vehicle front side, an arrow UP indicates a vehicle upper side, and an arrow LH indicates a left side in a vehicle width direction.

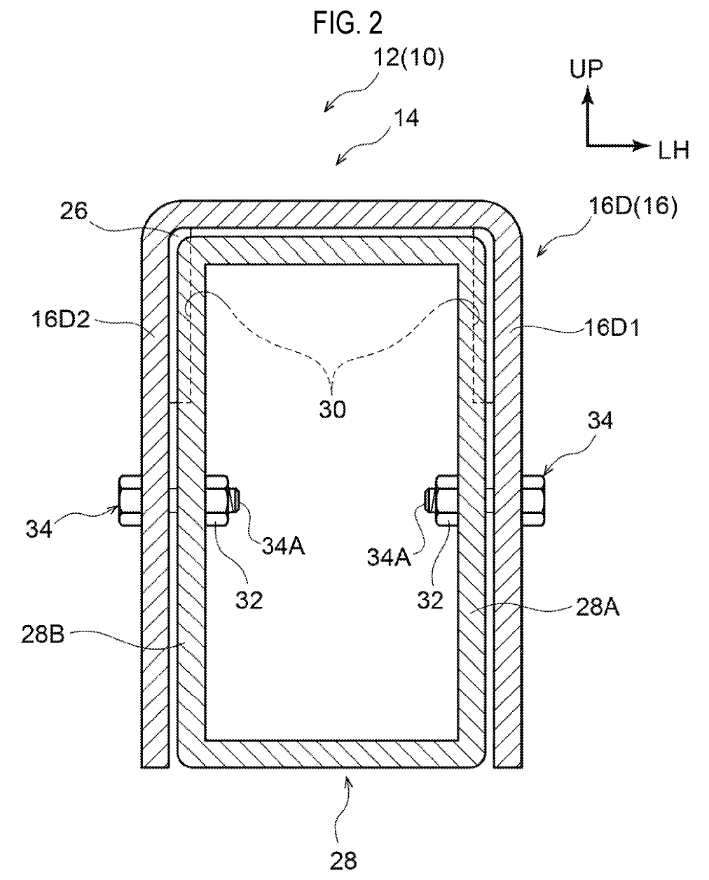

First, a schematic configuration of a vehicle 10 to which the vehicle body structure according to the present embodiment is applied will be described with reference to FIGS. 1 and 2. In the present embodiment, the vehicle 10 has basically a left-right symmetrical configuration. Therefore, hereinafter, the configuration of a portion on the left side in the vehicle width direction of the vehicle 10 will be described for the description of the portion common to both sides in the vehicle width direction. The description of the configuration of the portion on the right side in the vehicle width direction will be omitted as appropriate.

A vehicle body 12 of the vehicle 10 includes a front part 14, a center part (not shown), and a rear part (not shown) made of an aluminum die casting. The front part 14 is a vehicle body structural component made of an aluminum die casting and constitutes a portion on the vehicle front side. The center part constitutes a central portion of the vehicle in the vehicle front-rear direction and includes a battery pack serving as a battery and a center frame that holds the battery pack. The rear part constitutes a portion on the vehicle rear side. A power unit (not shown) including a motor or the like is mounted on the front part 14, and the power unit is driven by power supplied from the battery pack such that the vehicle 10 travels.

The front part 14 includes a pair of side structural portions 16 and a connecting portion 18 that connects the side structural portions 16 in the vehicle body width direction. Hereinafter, an assembly of the side structural portions 16 and the connecting portion 18 will be referred to as a main body portion 14A of the front part 14.

The side structural portion 16 is constituted by a suspension tower portion 16A, a wheel house portion 16B, a side member structural portion 16C, and a connecting portion 16D. The suspension tower portion 16A has a box shape in which a vehicle body lower side is opened and a through-hole portion 20 having a circular shape is disposed on an upper surface, and supports a shock absorber (not shown).

The wheel house portion 16B is provided integrally with the suspension tower portion 16A and has a spherical shape capable of accommodating a part of a tire (not shown). That is, the wheel house portion 16B has a shape that is opened to the outer side in the vehicle width direction and the vehicle lower side.

The side member structural portion 16C is disposed on the vehicle lower side of the suspension tower portion 16A, extends in the vehicle front-rear direction, and is provided integrally with the suspension tower portion 16A and the wheel house portion 16B.

In addition, a front pillar lower portion 22 is provided at a portion of the side structural portions 16 provided on an outer side in the vehicle width direction and at the vehicle rear side. The front pillar lower portion 22 extends rearward from the side structural portions 16 and extends in a vehicle up-down direction with the plate thickness direction oriented along the vehicle width direction, thereby constituting the portion of the front pillar 24 on the vehicle lower side.

Meanwhile, a connecting portion 16D is provided on the vehicle front side of the side structural portions 16. The connecting portion 16D has a U-shaped cross-sectional configuration as viewed in the vehicle front-rear direction, with the vehicle lower side open, and extends along the vehicle front-rear direction.

In addition, a pair of protruding portions 26 extending in the vehicle up-down direction is provided on an inner peripheral side of the connecting portion 16D. The protruding portion 26 is provided at each of a side wall portion 16D1 that constitutes a portion of the connecting portion 16D on the outer side in the vehicle width direction and a side wall portion 16D2 that constitutes a portion of the connecting portion 16D on the inner side in the vehicle width direction, at a central portion of the connecting portion 16D in the vehicle front-rear direction. The side member 28 is connected to the connecting portion 16D.

The side member 28 is formed in a tubular shape extending in the vehicle front-rear direction using an extrusion material of an aluminum alloy. Then, a groove portion 30 into which the protruding portion 26 is fitted is provided on each of an outer surface of a side wall portion 28A in the vehicle width direction and an inner surface of a side wall portion 28B in the vehicle width direction. The side wall portion 28A constitutes a portion of the side member 28 on the outer side in the vehicle width direction. The side wall portion 28B constitutes a portion of the side member 28 on the inner side in the vehicle width direction. The protruding portion 26 can be inserted into the groove portion 30 from an vehicle upper side.

In addition, at a end portion of the side member 28 on the vehicle rear side, a plurality of weld nuts 32 are spaced apart from each other in the vehicle front-rear direction and are respectively provided at central portions in the vehicle up-down direction on the inner side surface of the side wall portion 28A in the vehicle width direction and on the outer side surface of the side wall portion 28B in the vehicle width direction.

Meanwhile, through-hole portions (not shown) corresponding to the weld nuts 32 are disposed in the side wall portion 16D1 and the side wall portion 16D2 of the connecting portion 16D. Then, in a state where the end portion of the side member 28 on the vehicle rear side is disposed in the connecting portion 16D, a shaft portion 34A of a bolt 34 is disposed in the through-hole portions of the side wall portion 16D1 and the side wall portion 16D2, and the shaft portion 34A is fastened to the weld nuts 32. With such a structure, the side member 28 is fixed to the connecting portion 16D.

Returning to FIG. 1, the connecting portion 18 extends in the vehicle body width direction with the thickness direction aligned along the vehicle body front-rear direction, and is disposed along a front edge of the center part so as to partition the vehicle cabin 12A and the power unit housing 12B on the vehicle body lower side. In addition, a peripheral edge portion of the connecting portion 18 on a vehicle body upper side is recessed such that the protrude toward the vehicle body lower side, and a dashboard (not shown) is disposed in this portion.

### Action and Effects of Present Embodiment

Next, an action and an effect of the present embodiment will be described.

In the present embodiment, as shown in FIG. 1, the front part 14 is a metal casting and includes the main body portion 14A and the connecting portion 16D provided on the vehicle front side of the main body portion 14A. Therefore, in the present embodiment, the main body portion 14A and the connecting portion 16D are made of members subjected to press processing, or the like. The number of components constituting the front part 14 can be reduced as compared with a configuration in which these members are combined with each other by welding or the like to constitute the front part 14.

In addition, in the present embodiment, the side member 28 extending in the vehicle front-rear direction is provided, and an end portion of the side member 28 on the vehicle rear side is connected to the connecting portion 16D.

Meanwhile, it is conceivable that a portion where stress becomes high is generated at a connection portion between the side member 28 and the connecting portion 16D upon input of a collision load or the like.

Here, in the present embodiment, the end portion of the side member 28 on the vehicle rear side is disposed in the connecting portion 16D, and a bending moment or the like generated upon input of a collision load or the like can be supported by the side member 28 and the connecting portion 16D. It is possible to suppress the occurrence of a portion where stress becomes high at a connection portion between the side member 28 and the connecting portion 16D upon input of a collision load or the like.

On the other hand, the wheel house portion 16B and the like are provided in the front part 14, and the insertion direction of the side member 28 into the connecting portion 16D needs to be determined in consideration of the mold releasing direction during casting of the front part 14.

Here, in the present embodiment, the connecting portion 16D is opened to the lower side of the vehicle, and the insertion direction of the side member 28 into the connecting portion 16D can be aligned with a direction in which the wheel house portion 16B is opened, that is, a mold releasing direction during casting of the front part 14.

In addition, in the present embodiment, as shown in FIG. 2, the connecting portion 16D of the front part 14 is opened to the vehicle lower side. A sub-assembly in which various components such as the side member 28 and a front bumper reinforcement are combined can be lifted upward using a lift and attached to the front part 14.

That is, in the present embodiment, in a process of manufacturing the vehicle 10, an end portion of the side member 28 on the vehicle rear side is disposed in the connecting portion 16D from the vehicle lower side, and the sub-assembly including the connecting portion 16D and the side member 28 is connected.

In addition, in the present embodiment, the protruding portion 26 extending in the vehicle up-down direction is provided on the inner peripheral side of the connecting portion 16D, and the groove portion 30 into which the protruding portion 26 is fitted is formed in the side member 28. Therefore, in the present embodiment, the positioning of the connecting portion 16D and the side member 28 can be performed using the protruding portion 26 and the groove portion 30 as guides. In addition, a bending moment acting on the side member 28 can be supported by the protruding portion 26.

As described above, in the vehicle body structure according to the present embodiment, it is possible to suppress an increase in complexity of the manufacturing process of the vehicle body 12 while the number of components of the vehicle body 12 is reduced. Further, occurrence of a portion where stress on the vehicle body (12) becomes high can be suppressed upon input of a collision load or the like.

### Modification

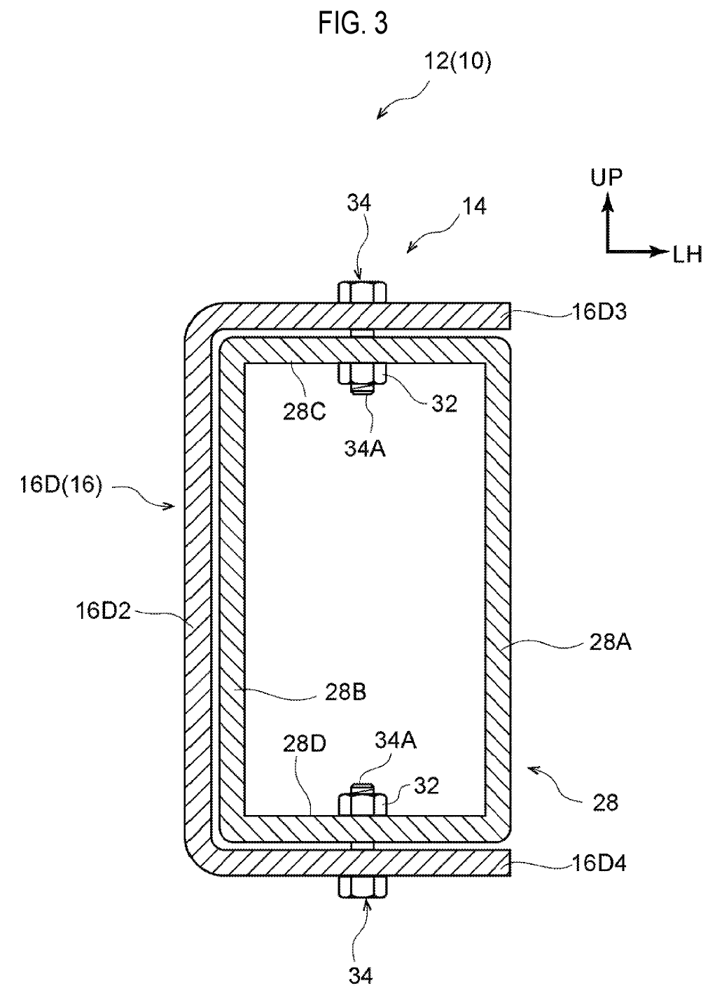

Hereinafter, a modification of the above-described embodiment will be described with reference to FIG. 3. The same components as those in the above-described embodiment will be denoted by the same reference numerals, and the description thereof will be omitted.

In this modification, the connecting portion 16D has a U-shaped cross-sectional configuration as viewed in the vehicle front-rear direction, with an outer side in the vehicle width direction open, and extends along the vehicle front-rear direction.

In addition, at the end portion of the side member 28 on the vehicle rear side, a plurality of weld nuts 32 are provided at intervals in the vehicle front-rear direction respectively at a center portion in the vehicle width direction of the lower surface of the upper wall portion 28C and at a center portion in the vehicle width direction of the upper surface of the lower wall portion 28D. The upper wall portion 28C constitutes a portion of the side member 28 on an upper side in the vehicle width direction. The lower wall portion 28D constitutes a portion of the side member 28 on the vehicle lower side.

Meanwhile, through-hole portions (not shown) corresponding to the weld nuts 32 are disposed in an upper wall portion 16D3 constituting a portion of the connecting portion 16D on the vehicle upper side and a side wall portion 16D4 constituting a portion of the connecting portion 16D on the vehicle lower side. Then, in a state where the end portion of the side member 28 on the vehicle rear side is disposed in the connecting portion 16D, a shaft portion 34A of a bolt 34 is disposed in the through-hole portions of the upper wall portion 16D3 and the side wall portion 16D4. The shaft portion 34A is fastened to the weld nuts 32, thereby fixing the side member 28 to the connecting portion 16D.

With such a configuration, the connecting portion 16D is opened to the outer side in the vehicle width direction, and the insertion direction of the side member 28 into the connecting portion 16D can be aligned with a direction in which the wheel house portion 16B is opened, that is, a mold releasing direction during casting of the front part 14.

That is, in the present modification, in a process of manufacturing the vehicle 10, an end portion of the side member 28 on the vehicle rear side is disposed in the connecting portion 16D from the outer side in the vehicle width direction, thereby connecting the connecting portion 16D and the side member 28.

The vehicle body structure according to the present embodiment can also be applied to a rear part in accordance with specifications of the vehicle 10.

What is claimed is:

1. A vehicle body structure comprising:
a vehicle body structural portion configured as a metal casting and including
a main body portion, and
a connecting portion provided on a vehicle front side of the main body portion and open to an outer side in a vehicle width direction or a vehicle lower side; and
a side member extending in a vehicle front-rear direction and connected to the connecting portion in a state where an end portion of the side member on a rear side in the vehicle front-rear direction is disposed in the connecting portion.

2. The vehicle body structure according to claim 1, wherein the connecting portion is opened to the vehicle lower side.

3. The vehicle body structure according to claim 2, wherein:
a protruding portion extending in a vehicle up-down direction is provided on an inner peripheral side of the connecting portion; and
a groove portion into which the protruding portion is fitted is provided in the side member.

4. A method of manufacturing a vehicle body, the method comprising:
inserting, from a vehicle lower side, an end portion of a side member on a vehicle rear side into a connecting portion that extends from a main body portion of a vehicle body structural portion made of a metal casting, and that is opened to the vehicle lower side; and
connecting the connecting portion and the side member.
